(19) United States
(12) Patent Application Publication
(10) Pub. No.: US 2025/0285174 A1
(43) Pub. Date: Sep. 11, 2025

(54) Integrated Truck Rental Comparison and Booking Application Utilizing Web Scraping Technology

(71) Applicant: Coleton Wright, Atlanta, GA (US)

(72) Inventor: Coleton Wright, Atlanta, GA (US)

(21) Appl. No.: 19/068,654

(22) Filed: Mar. 3, 2025

Related U.S. Application Data
(60) Provisional application No. 63/562,595, filed on Mar. 7, 2024.

(51) Int. Cl. G06Q 30/0645; G06F 16/951; G06Q 30/0601; G06Q 50/40

(52) U.S. Cl. CPC G06Q 30/0645; G06F 16/951; G06Q 30/0627; G06Q 30/0629; G06Q 50/40

(57) ABSTRACT

An integrated truck rental comparison and booking application uses web scraping technology to aggregate and compare rental options from multiple online sources, such as Uhaul.com and Budgettruck.com. The application allows users to input pick-up and drop-off locations, gather real-time rental information, and display it in a comparative layout. It features dynamic updates for pricing and availability and enables direct booking of selected rentals. Additionally, the application incorporates moving labor services, providing a comprehensive solution for users' moving needs. With a focus on data security and user privacy, this application addresses inefficiencies in the traditional truck rental process, offering a centralized platform that simplifies comparison and booking.

### FIELD OF THE INVENTION

The present invention generally relates to digital applications for facilitating comparison and booking services in the truck rental industry. More specifically, the present invention relates to an application that aggregates and compares truck rental options from multiple online sources to enable informed decision-making and efficient bookings through a single user interface.

### BACKGROUND OF THE INVENTION

The truck rental industry offers many options through various websites, such as Uhaul.com, Pensketruckrental.com, and Budgettruck.com. However, potential renters must visit each of these websites individually to compare prices and availability. This process is time-consuming and inefficient, leading to frustration for users.

Currently, there is no single platform that allows users to easily compare prices and book trucks from different providers. This lack of a centralized system creates a confusing experience for customers, who have to navigate multiple sites and deal with inconsistent information. As a result, many customers find the rental process difficult and may choose not to rent a truck at all.

Therefore, there is a need for a new method and system that can solve these problems.

The present invention is intended to solve the problems associated with conventional devices and methods and provide improvements on these methods and devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention addresses the aforementioned deficiencies by providing an integrated digital application designed to aggregate, compare, and display truck rental information from multiple online sources. The application employs advanced web scraping techniques to retrieve up-to-date rental information from websites such as Uhaul.com, Pensketruckrental.com, and Budgettruck.com. This information is then processed and presented in a user-friendly interface, allowing users to easily compare prices, availability, and other relevant details. Additionally, the application facilitates direct booking of truck rentals and will incorporate moving labor data, further enhancing the utility and comprehensiveness of the service.

### BRIEF DESCRIPTION OF THE DRAWINGS

FIG. 1 illustrates an online platform that embodies various aspects of the present invention, showcasing the user interface and interaction flow.

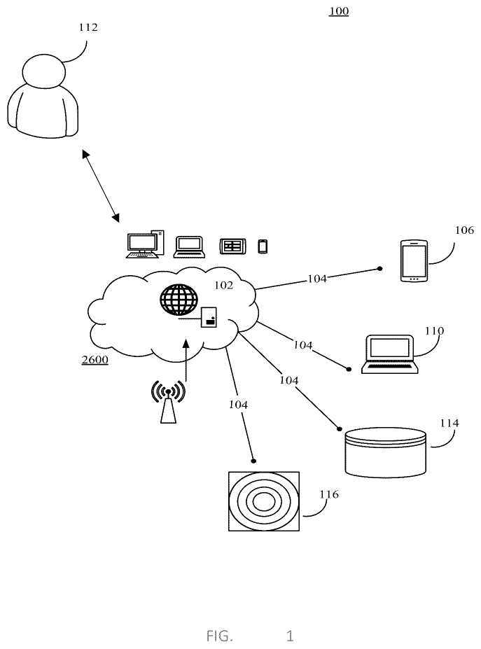

FIG. 2 presents a block diagram of a system designed to facilitate the functionalities of the invention, highlighting the key components and their interconnections.

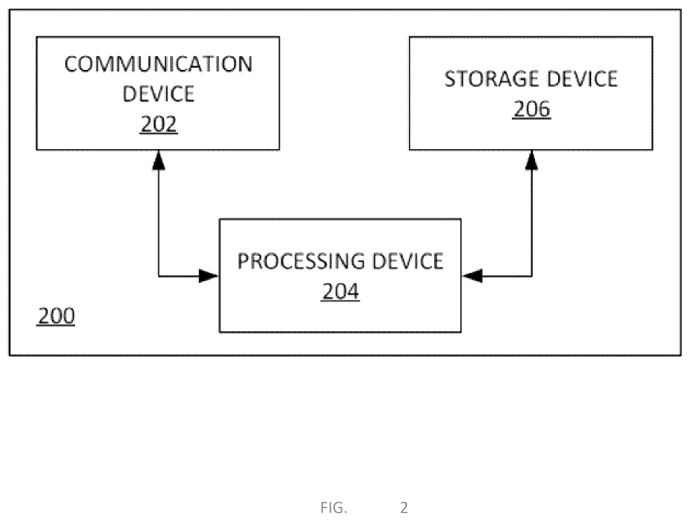

FIG. 3 depicts one embodiment of the method of the present invention, outlining the sequential steps involved in the data retrieval and processing for truck rental services.

FIG. 4 illustrates one embodiment of the system architecture of the present invention, detailing the modules responsible for data gathering, processing, and user interaction.

FIG. 5 provides an expanded view of one embodiment of the method, including additional detailed steps that enhance the user experience and data accuracy.

FIG. 6 showcases an alternative embodiment of the method of the present invention.

FIG. 7 illustrates another alternative method of the present invention.

FIG. 8 is a block diagram of a computing device configured to implement the methods disclosed herein, in accordance with certain embodiments, detailing the hardware and software components involved in the operation.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive.

Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present invention represents a significant advancement in digital applications for the truck rental industry. The present invention addresses the inefficiencies currently faced by users by consolidating rental options into a single platform and streamlining the comparison and booking process. By utilizing web scraping technology and a user-centered design, the application serves as a transformative tool in the marketplace.

### Overview of the Invention

The present invention is implemented through a software application that employs web scraping technology to programmatically access and extract data from various truck rental service websites. This scraping mechanism is optimized to handle different website layouts and data formats, ensuring the reliability and accuracy of the information retrieved.

Once the data is retrieved, it undergoes processing to standardize its format for comparison. The application then displays this information in a comparative layout, allowing users to make informed decisions based on price, truck availability, rental terms, and other criteria. A key feature of the application is its ability to dynamically update the displayed information, reflecting real-time changes in rental options.

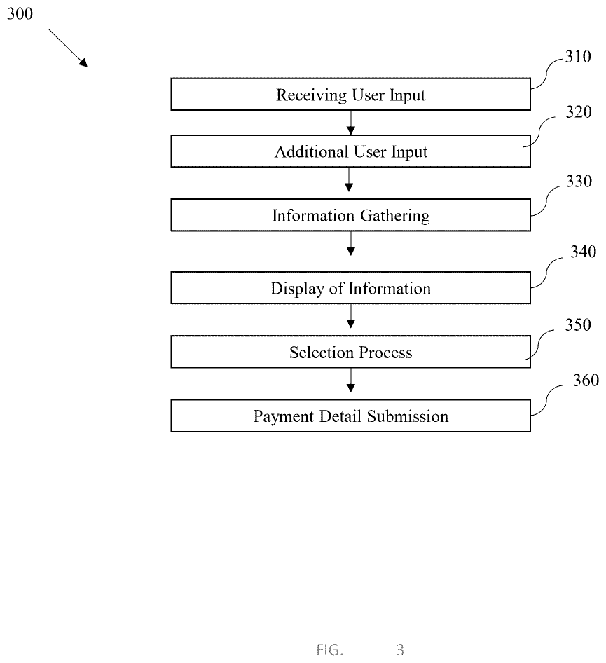

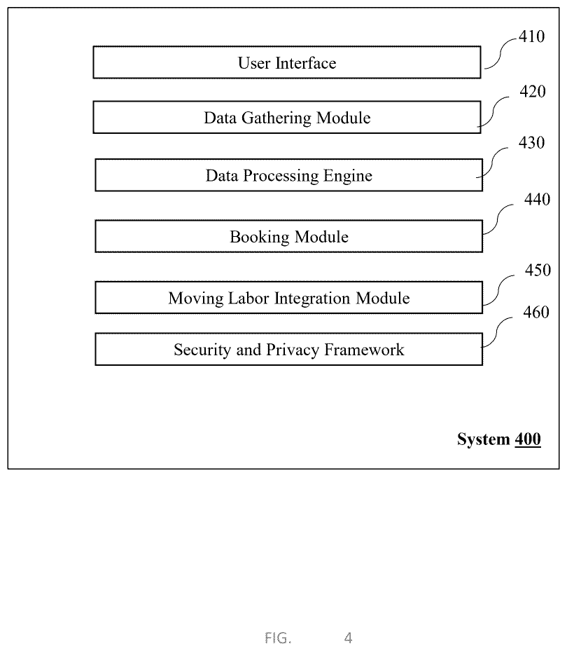

In a preferred embodiment, as shown in FIGS. 3-4, the present invention provides a method 300 and system 400 for aggregating and booking rental services, comprising the following steps and components:
1. Receiving User Input 310: The method begins by receiving input from a user specifying a desired pick-up location for a truck, container, or trailer.
2. Additional User Input 320: Following the initial input, the method involves receiving additional specifications from the user, including the pick-up date and desired drop-off location. Upon the user's submission of these details, the method progresses to the next step.
3. Information Gathering 330: The method actively gathers information relevant to the user's request from multiple sources, including Uhaul.com, Pensketruckrental.com, Budgettruck.com, Upack.com, and 1800Packrat.com. This step utilizes automated data extraction mechanisms to retrieve data from at least five different truck rental service websites.
4. Display of Information 340: After gathering the information, the method displays the various pricing options available from the aforementioned sources in a structured manner that facilitates easy comparison.
5. Selection Process 350: The method allows the user to select a preferred rental service provider from the displayed options. This selection process is user-driven, allowing for personal preference in the choice of rental service.
6. Payment Detail Submission 360: Following the selection of a preferred rental service provider, the method prompts the user to enter payment details. This step is crucial for securing the rental service from the selected provider. The payment details are processed through a secure payment gateway, ensuring compliance with data protection standards.

The system 400 may comprise the following components to facilitate the method:
User Interface 410: A graphical user interface (GUI) designed for ease of navigation and interaction, allowing users to input their rental preferences and view options.
Data Gathering Module 420: A module that employs web scraping technology to programmatically access and extract data from multiple truck rental service websites.
Data Processing Engine 430: An engine that processes the gathered rental information to standardize formats for comparison and dynamically updates the displayed rental options based on real-time data changes.
Booking Module 440: An integrated module that allows users to book their selected rental service directly through the application, facilitating a seamless transition from comparison to reservation.
Moving Labor Integration Module 450: A module that gathers information on available moving labor services, allowing users to access pricing and scheduling information alongside truck rental options.
Security and Privacy Framework 460: A framework that implements advanced encryption techniques and compliance with data protection regulations to safeguard user information and ensure secure data transmission.

### Real-Time Data Monitoring

In some embodiments, the application of the present invention may include a step that continuously monitors the extracted data for changes in pricing and availability. This real-time monitoring allows the application to update rental options based on the monitored data changes, utilizing a real-time data processing engine.

### User Interaction and Analytics

In some embodiments, the application of the present invention may be configured to log user interactions to improve the accuracy of future data retrieval, utilizing user behavior analytics. This feedback loop informs adjustments to the data retrieval algorithms, enhancing the overall efficiency of the application.

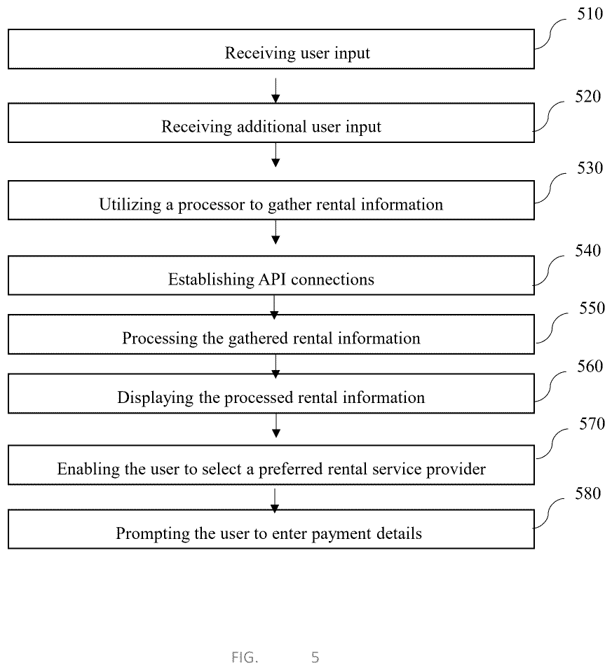

In one embodiment, as shown in FIG. 5, the present invention may provide a method comprising: receiving user input specifying a desired pick-up location for a truck rental at 510;
receiving additional user input including a pick-up date and a desired drop-off location at 520;
utilizing a processor to gather rental information from multiple online sources based on the received user inputs at 530;
establishing API connections with selected truck rental service providers to retrieve real-time rental data at 540;
   (API access, or connections, constitutes a fundamental technological framework within the fields of computer engineering and software development. This framework facilitates the communication between disparate software applications, thereby enabling developers to integrate a diverse array of services and functionalities into their respective applications. The utilization of API connections enhances the interoperability of software systems, allowing for the creation of more robust and feature-rich applications.)

The method may further include: processing the gathered rental information to standardize formats for comparison at 550;
displaying the processed rental information in a comparative layout to the user, including pricing options and availability at 560;
enabling the user to select a preferred rental service provider from the displayed options at 570; and
at 580, prompting the user to enter payment details to secure the rental service from the selected provider, wherein the payment details are processed through a secure payment gateway.

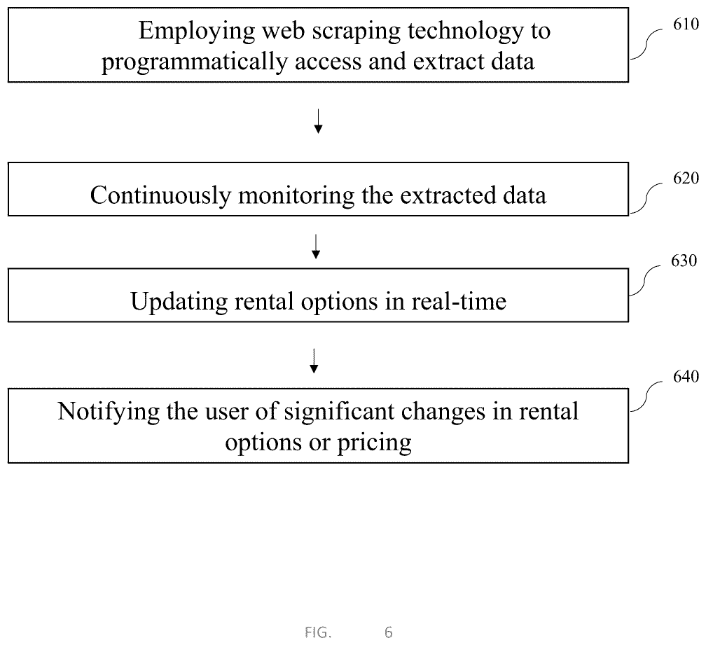

In another embodiment, as shown in FIG. 6, the present invention may provide a method comprising: employing web scraping technology to programmatically access and extract data from multiple truck rental service websites at 610;
continuously monitoring the extracted data for changes in pricing and availability at 620;
updating rental options in real-time based on the monitored extracted data changes, utilizing a real-time data processing engine, which analyzes data patterns to predict trends at 630; and
at 640, notifying the user of significant changes in rental options or pricing, via in-app notifications or alerts, wherein users can customize their notification preferences.

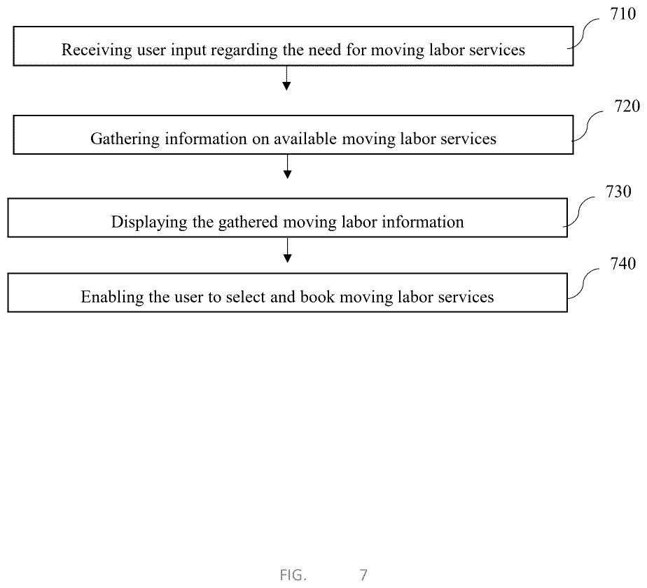

In yet another embodiment, as shown in FIG. 7, the present invention may provide a method comprising:
receiving user input regarding the need for moving labor services in conjunction with truck rental at 710;
gathering information on available moving labor services from multiple online sources at 720;
displaying the gathered moving labor information alongside truck rental options at 730; and
at 740, enabling the user to select and book moving labor services directly through the application, facilitated by a seamless booking interface, which confirms the booking through an automated notification.

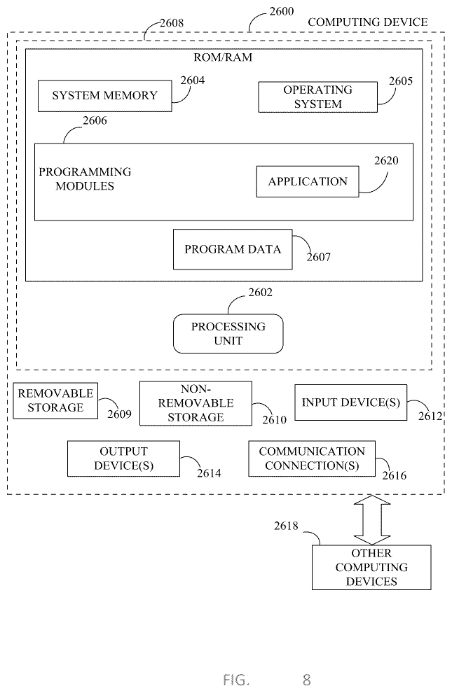

With reference to FIG. 8, a system consistent with an embodiment of the disclosure may include a computing device or cloud service, such as computing device 2600. In a basic configuration, computing device 2600 may include at least one processing unit 2602 and a system memory 2604. Depending on the configuration and type of computing device, system memory 2604 may comprise, but is not limited to, volatile (e.g., random-access memory (RAM)), non-volatile (e.g., read-only memory (ROM)), flash memory, or any combination. System memory 2604 may include operating system 2605, one or more programming modules 2606, and may include program data 2607. Operating system 2605, for example, may be suitable for controlling computing device 2600's operation. In one embodiment, programming modules 2606 may include a web scraping module, data processing engine, and booking module, among others. Furthermore, embodiments of the disclosure may be practiced in conjunction with a graphics library, other operating systems, or any other application program and are not limited to any particular application or system. This basic configuration is illustrated in FIG. 8 by those components within a dashed line 2608.

Computing device 2600 may have additional features or functionality. For example, computing device 2600 may also include additional data storage devices (removable and/or non-removable) such as, for example, magnetic disks, optical disks, or tape. Such additional storage is illustrated in FIG. 8 by a removable storage 2609 and a non-removable storage 2610. Computer storage media may include volatile and non-volatile, removable and non-removable media implemented in any method or technology for the storage of information, such as computer-readable instructions, data structures, program modules, or other data. System memory 2604, removable storage 2609, and non-removable storage 2610 are all examples of computer storage media (i.e., memory storage). Computer storage media may include, but are not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage, or other magnetic storage devices, or any other medium which can be used to store information and which can be accessed by computing device 2600. Any such computer storage media may be part of device 2600. Computing device 2600 may also have input device(s) 2612 such as a keyboard, a mouse, a pen, a sound input device, a touch input device, a location sensor, a camera, a biometric sensor, etc. Output device(s) 2614 such as a display, speakers, a printer, etc. may also be included. The aforementioned devices are examples, and others may be used.

Computing device 2600 may also contain a communication connection 2616 that allows device 2600 to communicate with other computing devices 2618, such as over a network in a distributed computing environment, for example, an intranet or the Internet. Communication connection 2616 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 2604, including operating system 2605. While executing on processing unit 2602, programming modules 2606 may perform processes including, for example, one or more stages of methods, algorithms, systems, applications, servers, databases as described above. The aforementioned process is an example, and processing unit 2602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or implement specific abstract data types. Moreover, embodiments of the disclosure may be practiced with other computer system configurations, including handheld devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list) include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drives), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method comprising:
receiving user input specifying a desired pick-up location for a truck rental;
receiving additional user input including a pick-up date and a desired drop-off location;
utilizing a processor to gather rental information from multiple online sources based on the received user inputs;
establishing API connections with selected truck rental service providers to retrieve real-time rental data;
processing the gathered rental information to standardize formats for comparison;
displaying the processed rental information in a comparative layout to the user, including pricing options and availability;
enabling the user to select a preferred rental service provider from the displayed options; and
prompting the user to enter payment details to secure the rental service from the selected provider, wherein the payment details are processed through a secure payment gateway.

2. The method of claim 1, further comprising:
providing a user-friendly interface designed for ease of navigation and interaction, implemented through a graphical user interface (GUI) on a computing device, wherein the user-friendly interface includes visual elements that facilitate user engagement.

3. The method of claim 1, wherein the step of gathering rental information includes:
retrieving data from at least five different truck rental service websites, with automated data extraction mechanisms, wherein the data extraction mechanisms utilize predefined protocols for data retrieval.

4. The method of claim 1, further comprising:
allowing the user to filter rental options based on specific criteria, including truck size, rental price, and rental terms, facilitated by an interactive filtering system, which updates the displayed rental options in real-time based on user selections.

5. The method of claim 1, wherein the payment details are securely processed using encryption techniques, ensuring compliance with data protection standards, and providing a confirmation of successful transaction to the user.

6. The method of claim 1, wherein the application includes a feature for users to save their preferred rental options for future reference, leveraging cloud storage solutions for data persistence, wherein the saved rental options are accessible across multiple devices.

7. The method of claim 1, further comprising:
providing a comparison chart that visually represents the differences between rental options, generated dynamically based on user-selected criteria, with interactive elements allowing users to sort and filter the displayed information.

8. The method of claim 1, wherein the application includes a customer support feature for users to ask questions or resolve issues, integrated with a chatbot or live chat functionality, which provides instant responses based on frequently asked questions.

9. A method comprising:
employing web scraping technology to programmatically access and extract data from multiple truck rental service websites;
continuously monitoring the extracted data for changes in pricing and availability;
updating rental options in real-time based on the monitored extracted data changes, utilizing a real-time data processing engine, which analyzes data patterns to predict trends.
notifying the user of significant changes in rental options or pricing, via in-app notifications or alerts, wherein users can customize their notification preferences.

10. The method of claim 9, further comprising:
storing historical pricing data to provide users with insights into pricing trends over time, analyzed through machine learning algorithms, which improve accuracy of future pricing predictions.

11. The method of claim 9, wherein the notification of significant changes includes alerts sent to the user via email or push notifications, ensuring timely communication of updates, with options for users to opt-in or opt-out of specific notifications.

12. The method of claim 9, wherein the real-time updates are displayed in a dedicated section of the user interface, designed for optimal user experience and accessibility, with responsive design principles applied for mobile and desktop views.

13. The method of claim 9, wherein the web scraping technology is optimized to handle different website layouts and data formats, enhancing data retrieval efficiency, and includes error handling mechanisms for failed data retrieval attempts.

14. The method of claim 9, wherein the application logs user interactions to improve the accuracy of future data retrieval, utilizing user behavior analytics, which inform adjustments to the data retrieval algorithms.

15. A method comprising:
receiving user input regarding the need for moving labor services in conjunction with truck rental;
gathering information on available moving labor services from multiple online sources;
displaying the gathered moving labor information alongside truck rental options;
enabling the user to select and book moving labor services directly through the application, facilitated by a seamless booking interface, which confirms the booking through an automated notification.

16. The method of claim 15, further comprising:
integrating user reviews and ratings for moving labor services into the application, utilizing a review aggregation system, wherein users can filter reviews based on criteria such as rating and recency.

17. The method of claim 15, wherein the moving labor services are displayed based on proximity to the user's specified pick-up location, enhanced by geolocation services, which provide users with estimated travel times to the service provider.

18. The method of claim 15, further comprising:
allowing users to schedule moving labor services for specific dates and times, implemented through a calendar integration feature, which syncs with the user's personal calendar applications.

19. The method of claim 15, further comprising:
allowing users to bundle truck rental and moving labor services for a discounted rate, promoted through a dynamic pricing model, which calculates discounts based on user selections and promotions.

20. The method of claim 15, further comprising:
providing users with estimated costs for moving labor services based on the distance and time required for the move, calculated using an algorithm that factors in various parameters, including traffic conditions and labor availability.
